(19) United States
(12) Patent Application Publication
(10) Pub. No.: US 2025/0086210 A1
(43) Pub. Date: Mar. 13, 2025

(54) System and Method for Deploying Customized Large Language Models to Assist Individuals with Disabilities

(71) Applicant: Dell Products L.P., Round Rock, TX (US)

(72) Inventors: Shaul Dar, Petach Tikva (IL); Rasa Raghavan, Verona, WI (US)

(21) Appl. No.: 18/464,330

(22) Filed: Sep. 11, 2023

(51) Int. Cl. G06F 16/33; G06F 16/332

(52) U.S. Cl. CPC G06F 16/3344; G06F 16/3326

(57) ABSTRACT

A method, computer program product, and computing system for processing a query from a user on a website. The query is classified to determine whether the query is associated with a user with a disability. In response to classifying the query as being associated with a user with a disability, the query is processed using a customized large language model (LLM).

### BACKGROUND

Approximately one billion people (15% of the world's population) live with a disability. According to the U.S. Center for Disease Control, 10.9% of U.S. adults experience cognition impairment, 5.7% experience hearing impairment, and 4.9% experience vision impairment. Article 21 of the United Nations Convention on the Rights of Persons with Disabilities defines access to information as a human right. Providing relevant information to individuals with disabilities in accessible formats and technologies that are appropriate to different kinds of disabilities, in a timely manner and without additional cost, is an important step in supporting this right. From a business perspective, increased accessibility enhances a company brand, extends market reach, and reduces legal risk.

Accessing information resources is difficult for individuals with disabilities. For example, when searching for a particular product or service, or for a feature or function that can help the individual, usability challenges arise. As an example, consider a person looking for a “laptop for hearing impaired.” In this example, a user may use a search engine to generate a query (e.g., “laptop for hearing impaired”). A resulting search engine result may include a page full of links (the top ones are paid advertisements), none of which provides a clear and useful answer to the question, and all of which require additional browsing and comprehension.

### SUMMARY OF DISCLOSURE

In one example implementation, a computer-implemented method executed on a computing device may include, but is not limited to, processing a query from a user on a website. The query is classified to determine whether the query is associated with a user with a disability. In response to classifying the query as being associated with a user with a disability, the query is processed using a customized large language model (LLM).

One or more of the following example features may be included. In response to classifying the query as not being associated with a user with a disability, the query is processed using a query processing engine associated with the website. Classifying the query as being associated with a user with a disability may include comparing one or more portions of the query against a database of phrases associated with disabilities. Classifying the query as being associated with a user with a disability may include processing the query using a classification-based machine learning model. A particular customized LLM may be identified based upon, at least in part, a classification associated with the query. Classifying the query as being associated with a user with a disability may include one or more of: performing a binary classification associated with the query, and performing a multi-class classification associated with the query. A result may be generated for the query using the customized LLM. Feedback from the user concerning the generated result may be processed to update the classifying of subsequent queries.

In another example implementation, a computer program product resides on a computer readable medium that has a plurality of instructions stored on it. When executed by a processor, the instructions cause the processor to perform operations that may include, but are not limited to, processing a query from a user on a website. The query is classified to determine whether the query is associated with a user with a disability. In response to classifying the query as being associated with a user with a disability, the query is processed using a customized large language model (LLM).

One or more of the following example features may be included. In response to classifying the query as not being associated with a user with a disability, the query is processed using a query processing engine associated with the website. Classifying the query as being associated with a user with a disability may include comparing one or more portions of the query against a database of phrases associated with disabilities. Classifying the query as being associated with a user with a disability may include processing the query using a classification-based machine learning model. A particular customized LLM may be identified based upon, at least in part, a classification associated with the query. Classifying the query as being associated with a user with a disability may include one or more of: performing a binary classification associated with the query, and performing a multi-class classification associated with the query. A result may be generated for the query using the customized LLM. Feedback from the user concerning the generated result may be processed to update the classifying of subsequent queries.

In another example implementation, a computing system includes at least one processor and at least one memory architecture coupled with the at least one processor, wherein the at least one processor configured to process a query from a user on a website. The query is classified to determine whether the query is associated with a user with a disability. In response to classifying the query as being associated with a user with a disability, the query is processed using a customized large language model (LLM).

One or more of the following example features may be included. In response to classifying the query as not being associated with a user with a disability, the query is processed using a query processing engine associated with the website. Classifying the query as being associated with a user with a disability may include comparing one or more portions of the query against a database of phrases associated with disabilities. Classifying the query as being associated with a user with a disability may include processing the query using a classification-based machine learning model. A particular customized LLM may be identified based upon, at least in part, a classification associated with the query. Classifying the query as being associated with a user with a disability may include one or more of: performing a binary classification associated with the query, and performing a multi-class classification associated with the query. A result may be generated for the query using the customized LLM. Feedback from the user concerning the generated result may be processed to update the classifying of subsequent queries.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and an disability access assistance process coupled to a distributed computing network according to one or more example implementations of the disclosure;

FIG. 2 is an example flowchart of the disability access assistance process according to one or more example implementations of the disclosure;

FIG. 3 is an example of a result for a query using a conventional search engine;

FIG. 4 is an example diagrammatic view of the disability access assistance process according to one or more example implementations of the disclosure;

FIG. 5 is an example of the layers of a large language model (LLM) according to one or more example implementations of the disclosure;

FIG. 6 is an example view of in-context learning for customizing a LLM according to one or more example implementations of the disclosure; and

FIG. 7 is an example view of a result generated by a customized LLM in response to a query classified as being associated with a user with a disability according to one or more example implementations of the disclosure.

Like reference symbols in the various drawings indicate like elements.

### DETAILED DESCRIPTION

### System Overview

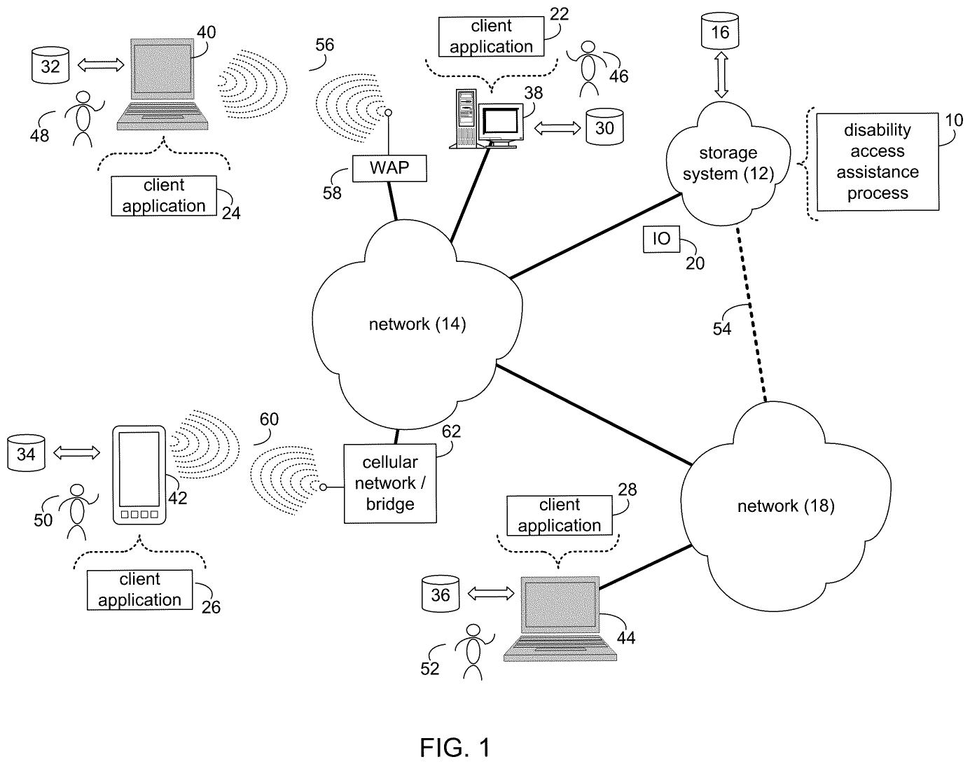

Referring to FIG. 1, there is shown disability access assistance process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of disability access assistance process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of disability access assistance process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a data replication process, such as disability access assistance process 10 of FIG. 1, may include but is not limited to, processing a query from a user on a website. The query is classified to determine whether the query is associated with a user with a disability. In response to classifying the query as being associated with a user with a disability, the query is processed using a customized large language model (LLM).

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Disability Access Assistance Process:

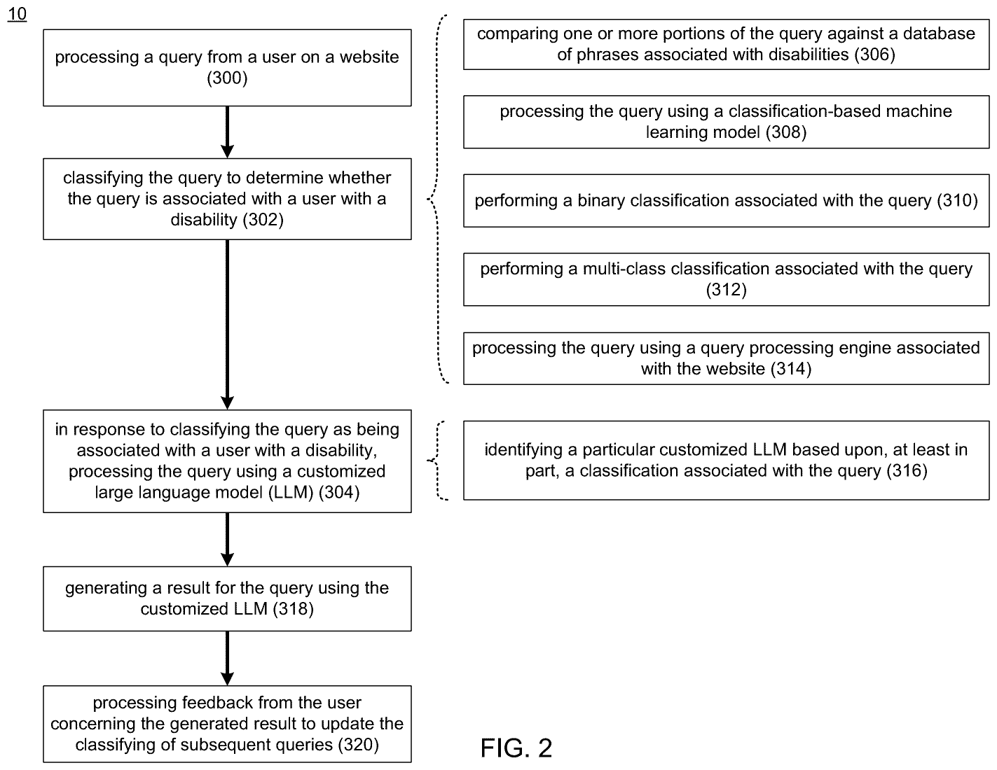

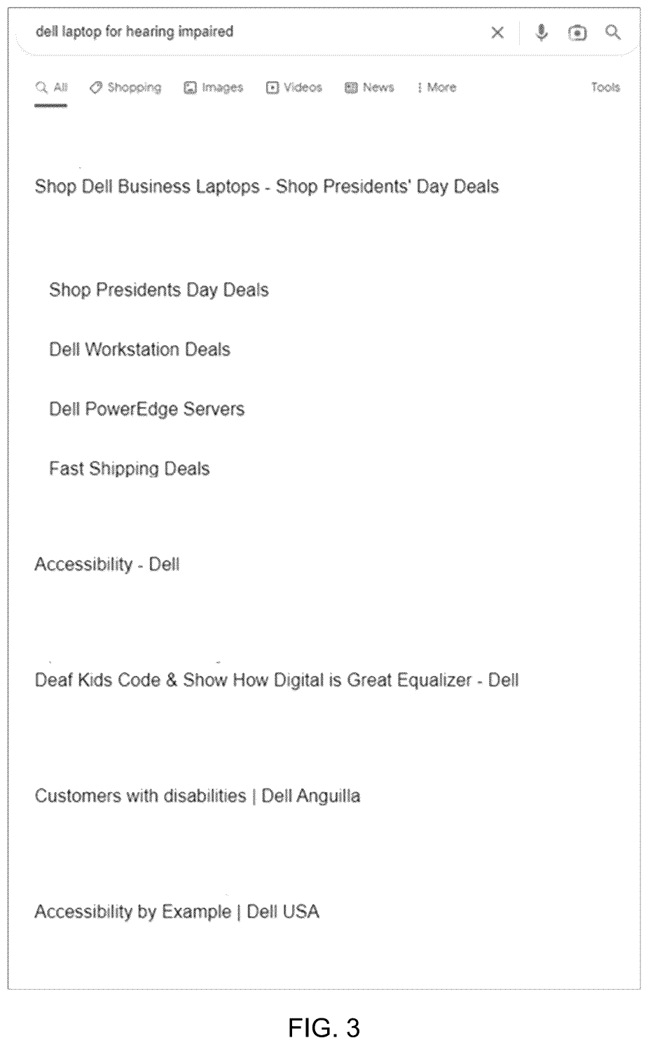

Referring also to the examples of FIGS. 2-3 and in some implementations, disability access assistance process 10 may process 300 a query from a user on a website. The query is classified 302 to determine whether the query is associated with a user with a disability. In response to classifying the query as being associated with a user with a disability, the query is processed 304 using a customized large language model (LLM).

As will be discussed in greater detail below, implementations of the present disclosure may allow for advances in artificial intelligence, particularly generative artificial intelligence, to provide more effective responses to queries for individuals with disabilities. For example, people with disabilities often face a usability challenge when searching for a particular product or service, or for a feature or function that can help them when using a website or other Internet-connected browser. Using conventional browsers or other Internet-connected resources, these tools may be ineffective at providing meaningful responses to queries. For example, suppose a user (e.g., user 46) provides a query for a “laptop for hearing impaired”. In this example, a conventional search engine may provide a page full of links, where the first links are paid advertisements as shown in FIG. 3. Each of these links require additional browsing and contextual comprehension. Rather, these links fail to provide any clear or useful answers. As will be discussed in greater detail below, implementations of the present disclosure use a customized large language model (LLM) to provide contextual responses that are customized for responding to a disability identified from the query or other associated information (e.g., receiving devices, type of query, past query history, etc.). In this manner, disability access assistance process 10 can provide more meaningful answers to queries using a LLM that is customized to address queries concerning disabilities.

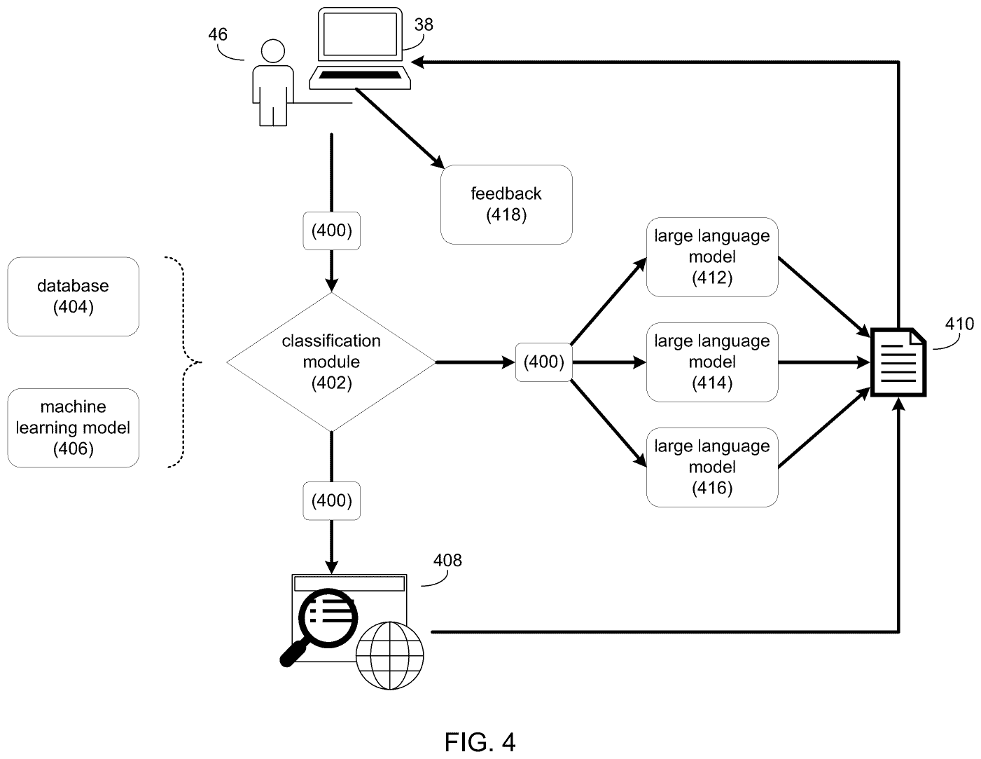

In some implementations, disability access assistance process 10 processing a query from a user on a website. A query may generally include a representation of a request from a user concerning a service or for information concerning a particular topic. For example, a query may include a question (e.g., “where can I purchase a laptop with hearing impairment features?”) or a text description for information (e.g., “best monitor settings to reduce overstimulation in ASD”). A query may also include multi-modal requests (e.g., a text description and a visual representation of a selected icon from a user interface; a speech signal with contextual information; a video file including a recording of a user asking a question; etc.). In each of these examples, the query may directly concern a disability (e.g., a text description for tablets and screens for those with visual impairments) or may be influenced by a disability (e.g., speech input may including vocal characteristics associated with a speech impediment). Accordingly, a query may be provided in various manners to a website or other resource to resolve the query. Referring also to FIG. 4, a user (e.g., user 46) may use a computing device (e.g., client electronic device 38) to submit a query (e.g., query 400) to a website. In one example, the website may include a specific website associated with a particular company or service. In another example, the website may be a general search engine or other browsing entry website from which users explore other websites.

In some implementations, disability access assistance process 10 classifies 302 the query to determine whether the query is associated with a user with a disability. Classifying 302 a query may generally include determining a class, topic, or type for the query. In some implementations, disability access assistance process 10 may classify 302 the query to determine whether the query is associated with or concerns a user with a disability. For example, classifying 302 the query may include processing the content of the query and/or contextual information associated with the source of the query. In one example, disability access assistance process 10 classifies 302 query 400 to determine whether query 400 is associated with a user living with a disability by processing the content of query 400. In this example, suppose query 400 includes a text-based query in a search engine for “dell laptop for hearing impaired”. In this example and as will be discussed in greater detail below, disability access assistance process 10 processes query 400 for predefined words or phrases associated with different types of disabilities. Accordingly, disability access assistance process 10 may classify 302 query 400 based on the content of query 400 itself. In another example, disability access assistance process 10 may receive query 400 from a computing device (e.g., client electronic device 38) with metadata or configuration information indicative of accessibility features associated with users with disabilities. For example, suppose disability access assistance process 10 determines from information associated with client electronic device 38 that client electronic device 38 has enabled hearing-impairment assistance functionality. In this example and subject to any privacy restrictions enabled by the user, disability access assistance process 10 may use contextual information (e.g., metadata of query 400, metadata associated with client electronic device 38, metadata with information concerning user 46, etc.) to classify 302 query 400 as being associated with a user with a disability. As shown in FIG. 4, the classification of query 400 is shown as classification module 402. In some implementations, classification module 402 may include a hardware and/or software component configured to process query 400 and/or content associated with query 400 to classify 302 query 400 as being associated with a user with a disability.

In some implementations, classifying 302 the query as being associated with a user with a disability includes comparing 306 one or more portions of the query against a database of phrases associated with disabilities. Referring again to FIG. 4, classification module 402 may include access to a database (e.g., database 404). Database 404 may include a plurality of text, speech, and/or image portions that reference or concern disabilities. For example, database 404 may include text portions or keywords that may be indicative of a user with disabilities. Returning to the above example where user 46 provides query 400 with the text “dell laptop for hearing impaired”, disability access assistance process 10 classifies 302 query 400 as being associated with a user with a disability by comparing 306 one or more portions of query 400 (e.g., each word of query 400) with predefined words from database 400. Specifically, disability access assistance process 10 may classify 302 query 400 as being associated with a user with a hearing impairment based upon the comparison of the words “hearing impairment” with one or more entries of database 404.

In some implementations, classifying 302 the query as being associated with a user with a disability includes processing 308 the query using a classification-based machine learning model. A machine learning model may generally include an algorithm or combination of algorithms that has been trained to recognize certain types of patterns. For example, machine learning approaches may be generally divided into three categories, depending on the nature of the signal available: supervised learning, unsupervised learning, and reinforcement learning. Supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). Reinforcement learning may generally include a computing device interacting in a dynamic environment in which it must perform a certain goal (such as driving a vehicle or playing a game against an opponent). As it navigates its problem space, the machine learning model is provided feedback that is analogous to rewards, which it tries to maximize. While three examples of machine learning approaches have been provided, it will be appreciated that other machine learning approaches are possible within the scope of the present disclosure.

In some implementations, a classification-based machine learning model (e.g., machine learning model 426) is a machine learning model configured to classify data into classes based on certain characteristics of the data. For example, classifying 302 the query as being associated with a user with a disability may include one or more of: performing 310 a binary classification associated with the query, and performing 312 a multi-class classification associated with the query. In one example, machine learning model 426 may be trained to classify query 400 by performing 310 a binary classification. A binary classification is a classification of the query as being associated with a user with disability generally, or as not being associated with a user with disability. In this example and as will be discussed in greater detail below, disability access assistance process 10 may process 304 a query classified as being associated with a user with a disability by using a customized LLM that is more effective at being responsive to individuals with disabilities or more effective at providing relevant information concerning disabilities than conventional search engines used by many websites.

In some implementations, disability access assistance process 10 classifies 302 the query as being associated with a user with a disability includes performing 312 a multi-class classification associated with a query. A multi-class classification is a classification of the query into one of a plurality of classes. In this example, a machine learning model (e.g., machine learning model 406) can classify 302 query 400 as being associated with a particular class of a plurality of classes. In one example, classes may be defined for different types of disabilities, different types of queries, and/or combinations thereof. In this manner and as will be discussed in greater detail below, disability access assistance process 10 may process 304 the query using a class-specific customized LLM.

In some implementations and in response to classifying the query as not being associated with a user with a disability, disability access assistance process 10 processes 314 the query using a query processing engine associated with the website. Referring again to FIG. 4, suppose that disability access assistance process 10 classifies 302 query 400 as not being associated with a user with a disability. In this example, disability access assistance process 10 processes 314 query 400 using a query processing engine (e.g., query processing engine 408) associated with a website or other resource. A query processing engine 408 may include a publicly or privately accessible search engine or algorithm that searches local or Internet-based resources based on the query. In this example, because the query is classified as not being associated with a user with a disability, query processing engine 408 may provide sufficiently relevant and understandable results (e.g., result 410) to the user (e.g., user 46).

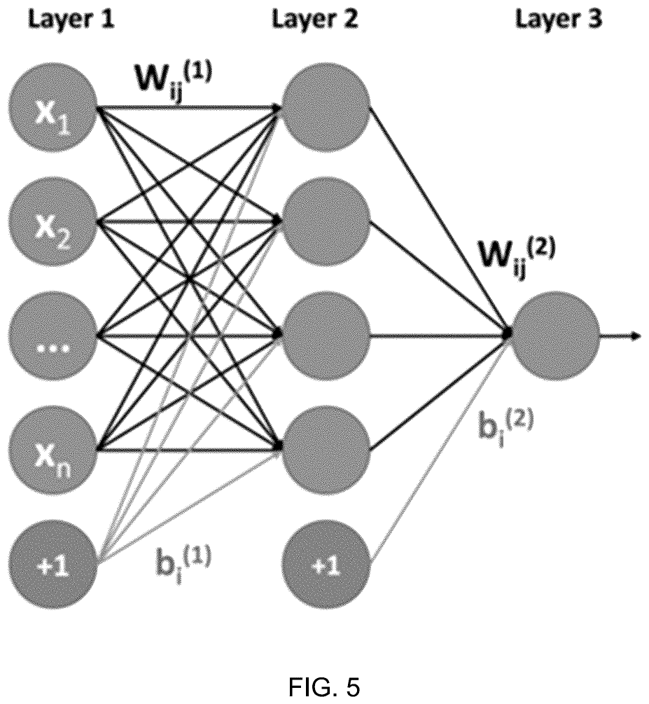

In some implementations and in response to classifying the query as being associated with a user with a disability, disability access assistance process 10 processes 304 the query using a customized large language model (LLM). For example, instead of using a conventional search engine to address queries that are classified as being associated with a user with a disability, a recent alternative is the use of a large language model (LLM) such as ChatGPT. An LLM is a highly-compressed representation of the collective knowledge present on the Internet. LLMs are a particular type of neural network. The architecture (or structure) of such a network comprises many layers (called hidden layers) that connect the input layer to the output layer as shown in FIG. 5. Values flow in this network from left to right. Every node in these layer has associated weights (denoted by the Wᵢⱼ and Bᵢ parameters) that define the calculation applied to the input values for this node in order to create the output values of the node, which in turn are passed on as input to nodes in the next layer. Essentially this calculation is a linear transformation of the input vector X to derive the output vector Y, i.e. Y=Wᵢ(X)+Bᵢ. The learning or training process of such a network works by comparing the current output of the network to the desired output (e.g., labeled examples) and then minimizing the gap (or error) through a process called back propagation, which adjusts the network weights in reverse order, from output to input. This optimization process is repeated until the error is sufficiently small.

In some implementations, large LLMs can have a huge number of parameters (i.e., the weights all of the nodes), with 175 billion in the case of GPT (i.e., the model underlying ChatGPT), and are often trained over many months on very large and highly curated datasets (e.g., 45 TB, or equivalently hundreds of billions of words, for ChatGPT,). The cost associated with building these models can be prohibitive, and thus the ability to use a pre-trained LLM offers considerable time and cost savings.

With fine-tuning, a pretrained neural network is customized or specialized for a specific task, which in the context of the present disclosure is to provide answers that are most useful for users with disabilities. This process typically requires a far smaller dataset (e.g., 100K words) and is therefore orders of magnitude faster and cheaper than full model training. Technically, fine-tuning works by changing the network weights so that the network is optimized (i.e., the error is minimized) for the specific task, or set of tasks, the LLM is being customized for.

In some implementations, customizing a LLM may involve a training set of a few thousand curated questions and answers. In principle, fine-tuning an LLM in such a way can affect not only the content of the answers, but also their format. While fine-tuning can provide very good results, it cannot be done with closed-source models such as ChatGPT, where the network weights are “frozen” and cannot be updated. Rather, in-context or few-shot learning through prompt design allows LLMs to be customized by taking a few task-specific examples (e.g., usually less than ten) as input, and then quickly figuring out how to perform well on that task. In some implementations, this process occurs as part of model inference, not training. No backpropagation takes place and the model weight are not changed. This allows closed-source models to be customized to particular applications (e.g., providing responses to queries associated with a user with a disability). In-context learning may seem like magic, and although it is understood to work by some combination of location-independent model parameters (i.e., known as attention) and location dependent parameters (i.e., known as positional embeddings), the inner working of in-context learning are not fully understood.

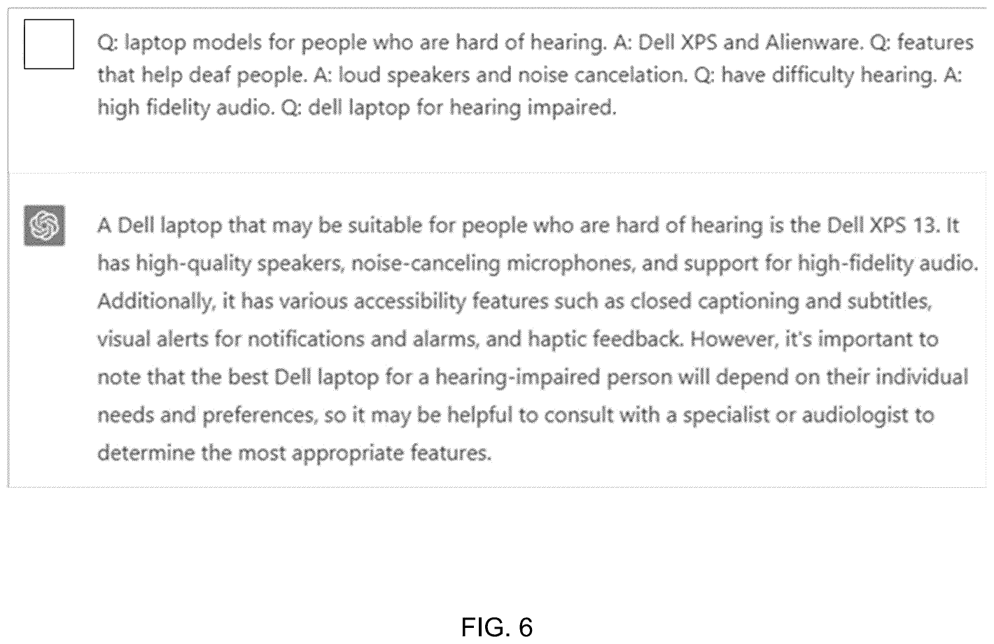

For example, disability access assistance process 10 may customize a general LLM via in-context learning for responding to queries for users with a disability by giving it a “prompt” (i.e., a query containing a short sequence of examples, each example having a question and matching answer). For example, this is shown in FIG. 6. In some implementations, the in-context sequence may includes dozens to hundreds of relevant examples.

The above-described methods (i.e., fine-tuning and in-context learning) have tradeoffs between them. In-context learning is applicable even when the pre-trained model is “frozen” and can work with a very small number of examples. However, it increases the inference cost considerably, and since no learning takes place the customization has to be done for each individual query. Fine-tuning can be done once as an additional training phase and be used many times, and hence it is the preferable option for open-source models, if a large enough set of fine-tuning examples is available.

Referring again to FIG. 4, an LLM (e.g., large language models 412, 414, 416) often provides more concise and relevant answers than a search engine, albeit with a small risk that the answers may be incorrect. As an example, suppose disability access assistance process 10 classifies query 400 as being associated with a user with a disability. In this example, disability access assistance process 10 processes 304 query 400 with a customized LLM (e.g., LLM 412).

In some implementations, disability access assistance process 10 may identify 316 a particular customized LLM based upon, at least in part, a classification associated with the query. For example, disability access assistance process 10 may identify 316 a customized LLM that is more specific to a particular query. Suppose LLM 412 is specialized for hearing impairment product recommendations, LLM 414 is customized for visual impairment product recommendations, and LLM 416 is customized for adapting electronic devices to users with developmental disabilities. Accordingly, when classifying 302 query 400, disability access assistance process 10 may perform 314 multi-class classification on query 400 to determine that query 400 is associated with a user with a hearing impairment disability. Accordingly, disability access assistance process 10 processes 304 query 400 using LLM 412.

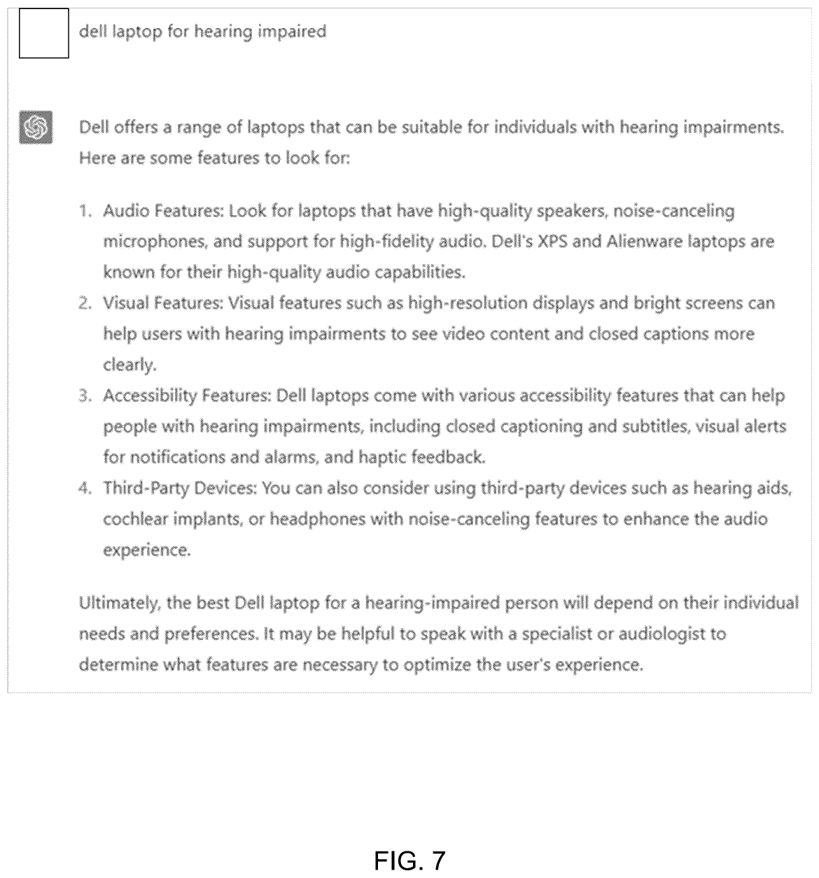

In some implementations, disability access assistance process 10 generates 318 a result for the query using the customized LLM. For example, LLM 412 may provide interactive prompts to the user (e.g., user 46) to generate result 410. Result 410 may be updated with each additional prompt and response from LLM 412. An example of result 410 generated by LLM 412 is shown in FIG. 7. Result 410 may include a dialogue in text form, a text-to-speech audio output, and/or a visual result in the form of navigating a website. For example, in addition to describing a laptop that can help those with a hearing impairment, result 410 may include a script or other executable code to render relevant results in a browser on client electronic device 38.

In some implementations, disability access assistance process 10 processes 320 feedback from the user concerning the generated result to update the classifying of subsequent queries. For example, as users interact with disability access assistance process 10 following such queries, disability access assistance process 10 tracks and measures the feedback provided by the user engagement. Typical metrics of engagement include time on site, pages per session, conversion rate or dollars spent, customer satisfaction (e.g. via survey), etc. By analyzing such metrics, disability access assistance process 10 determines the benefit of either the single LLM or multiple LLM approaches compared to the existing usage of a generic search engine to answer user queries.

In some implementations, disability access assistance process 10 can perform A/B testing by routing a certain percentage of the queries issued by disabled users (as determined by the initial classification model) to query processing engine 408, and the others to the LLM(s) (e.g., LLMs 412, 414, 416), and comparing the user engagement resulting from of these approaches.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing a query from a user on a website;
classifying the query to determine whether the query is associated with a user with a disability; and
in response to classifying the query as being associated with a user with a disability, processing the query using a customized large language model (LLM).

2. The computer-implemented method of claim 1, in response to classifying the query as not being associated with a user with a disability, processing the query using a query processing engine associated with the website.

3. The computer-implemented method of claim 1, wherein classifying the query as being associated with a user with a disability includes comparing one or more portions of the query against a database of phrases associated with disabilities.

4. The computer-implemented method of claim 1, wherein classifying the query as being associated with a user with a disability includes processing the query using a classification-based machine learning model.

5. The computer-implemented method of claim 1, further comprising:
identifying a particular customized LLM based upon, at least in part, a classification associated with the query.

6. The computer-implemented method of claim 1, wherein classifying the query as being associated with a user with a disability includes one or more of:
performing a binary classification associated with the query, and
performing a multi-class classification associated with the query.

7. The computer-implemented method of claim 1, further comprising:
generating a result for the query using the customized LLM; and
processing feedback from the user concerning the generated result to update the classifying of subsequent queries.

8. A computer program product residing on a non-transitory computer readable medium having a plurality of instructions stored thereon which, when executed by a processor, cause the processor to perform operations comprising:
processing a query from a user on a website;
classifying the query to determine whether the query is associated with a user with a disability; and
in response to classifying the query as being associated with a user with a disability, processing the query using a customized large language model (LLM).

9. The computer program product of claim 8, in response to classifying the query as not being associated with a user with a disability, processing the query using a query processing engine associated with the website.

10. The computer program product of claim 8, wherein classifying the query as being associated with a user with a disability includes comparing one or more portions of the query against a database of phrases associated with disabilities.

11. The computer program product of claim 8, wherein classifying the query as being associated with a user with a disability includes processing the query using a classification-based machine learning model.

12. The computer program product of claim 8, wherein the operations further comprise:
identifying a particular customized LLM based upon, at least in part, a classification associated with the query.

13. The computer program product of claim 8, wherein classifying the query as being associated with a user with a disability includes one or more of:
performing a binary classification associated with the query, and performing a multi-class classification associated with the query.

14. The computer program product of claim 8, wherein the operations further comprise:
generating a result for the query using the customized LLM; and
processing feedback from the user concerning the generated result to update the classifying of subsequent queries.

15. A computing system comprising:
a memory; and
a processor configured to process a query from a user on a website, to classify the query to determine whether the query is associated with a user with a disability, and in response to classifying the query as being associated with a user with a disability, to process the query using a customized large language model (LLM).

16. The computing system of claim 15, in response to classifying the query as not being associated with a user with a disability, processing the query using a query processing engine associated with the website.

17. The computing system of claim 15, wherein classifying the query as being associated with a user with a disability includes comparing one or more portions of the query against a database of phrases associated with disabilities.

18. The computing system of claim 15, wherein classifying the query as being associated with a user with a disability includes processing the query using a classification-based machine learning model.

19. The computing system of claim 15, wherein the processor is further configured to:
identify a particular customized LLM based upon, at least in part, a classification associated with the query.

20. The computing system of claim 15, wherein classifying the query as being associated with a user with a disability includes one or more of:
performing a binary classification associated with the query, and
performing a multi-class classification associated with the query.
